(19) United States
(12) Patent Application Publication
(10) Pub. No.: US 2025/0274900 A1
(43) Pub. Date: Aug. 28, 2025

(54) MANAGING WI-FI SCANS USING MEASUREMENTS FROM OTHER USER DEVICES

(71) Applicant: Apple Inc., Cupertino, CA (US)

(72) Inventors: Brian S. Smith, San Diego, CA (US); Wuzhou Zhang, Milpitas, CA (US); Isaac T. Miller, Half Moon Bay, CA (US); Glenn D. MacGougan, San Jose, CA (US); Robert W. Mayor, Half Moon Bay, CA (US)

(73) Assignee: Apple Inc., Cupertino, CA (US)

(21) Appl. No.: 19/043,243

(22) Filed: Jan. 31, 2025

Related U.S. Application Data
(60) Provisional application No. 63/556,740, filed on Feb. 22, 2024.

(51) Int. Cl. H04W 64/00; H04W 4/024; H04W 24/08; H04W 84/12

(52) U.S. Cl. CPC H04W 64/00; H04W 4/024; H04W 24/08; H04W 84/12

(57) ABSTRACT

The disclosed techniques can use a mobile device of a user to identify a particular network associated with a dwell location and perform location positioning (or measurements) to obtain an accurate location (e.g., a location value) of the particular network connected to an electronic device. The mobile device can share the location value with the electronic device of the same user through a cloud service account, such that the electronic device can avoid performing Wi-Fi scans to determine the dwell location.

### CROSS-REFERENCES TO OTHER APPLICATIONS

This application claims priority to U.S. Provisional Application No. 63/556,740, for “MANAGING WI-FI SCANS USING MEASUREMENTS FROM OTHER USER DEVICES” filed on Feb. 22, 2024, which is herein incorporated by reference in its entirety for all purposes.

### BACKGROUND

As smart electronic devices (e.g., Apple TV®, HomePod®, lights) become more prevalent, these smart electronic devices can be used to enable smart home automation. These smart electronic devices may use wireless fidelity (Wi-Fi) scans to adjust their functions and settings automatically based on a user's presence to provide a better user experience. However, Wi-Fi scans may consume the network bandwidth or interfere with other network communication, leading to performance issues for smart electronic devices. Thus, there is a need to address these challenges and others.

### SUMMARY

The present disclosure generally relates to wireless communications. More specifically, but not by way of limitation, techniques are described for managing W-Fi scans for smart home devices by using location measurements from a mobile device.

One general aspect includes a method. The method also includes receiving a trigger signal indicating an electronic device is to determine a current location of the electronic device. The method also includes determining, using a first wireless protocol, that the electronic device is connected to a local wireless network having a network identification (id), the local wireless network being at a dwell location associated with a user as defined by a mobile device of the user. The method also includes checking, using the network id, a database to determine whether the local wireless network is associated with the dwell location, the database storing a location value associated with the dwell location as measured by the mobile device, where the location value is determined by the mobile device using multiple measurements using wireless communications to devices external to the dwell location and having known locations. The method also includes when the local wireless network is associated with the dwell location, using the location value as the current location. The method also includes responsive to determining, using the first wireless protocol, that the electronic device is not connected to the local wireless network: performing a scan using the first wireless protocol to identify a plurality of networks, and using locations of the plurality of networks to determine the current location. Other embodiments of this aspect include corresponding computer systems, apparatus, and computer programs recorded on one or more computer storage devices, each configured to perform the actions of the methods.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 is a simplified diagram illustrating a technique for determining a dwell location by a home device of a smart home, according to some embodiments.

FIG. 2 is a simplified functional diagram of a home device of a smart home, according to some embodiments.

FIG. 3 is a simplified functional diagram of a mobile device assisting in determining the location of a smart home, according to some embodiments.

FIG. 4 is a simplified diagram illustrating a system for managing Wi-Fi scans using measurements of a mobile device, according to some embodiments.

FIG. 5 is a sequence diagram illustrating a data flow of the system of FIG. 4 for managing Wi-Fi scans using measurements of a mobile device, according to some embodiments.

FIG. 6 is a flowchart illustrating a method for managing Wi-Fi scans using measurements of a mobile device, according to some embodiments.

FIG. 7 is a block diagram of an example device, which may be a mobile device, according to some embodiments.

### DETAILED DESCRIPTION

Wi-Fi scans may consume the network bandwidth of smart electronic devices (called home devices for smart home automation) or interfere with other network communication, leading to performance issues for the electronic devices. Additionally, crowdsourced location information obtained using Wi-Fi scans may not be reliable because signals from nearby wireless networks may fluctuate or may be unstable. As a result, the unreliable location information may affect the smart home automation. Thus, there is a need to address these challenges and others.

The techniques disclosed in the present disclosure can use a mobile device (e.g., a mobile phone or a wearable watch) of a user to identify a particular network (e.g., with a network identification (ID)) that is a home network, work network, or a network associated with a location where the user stays at for sufficient time (referred to as a dwell location), and perform measurements (e.g., by using GPS measurements or a combination of different location sensors) to obtain an accurate location (referred to as measured location by the mobile or final location) of the particular network. The particular network may be referred to as a personalized associated access point (PAAP). The mobile device can also verify whether the location information (referred to as provider location) provided by a location service provider for the particular network matches the measured location. This verified location information (referred to as associated network state information), including a status (e.g., match or no match), network ID of the particular network, and geographic location (or location value, e.g., measured location) of the personalized associated AP can be encrypted, stored in a database table of the user's cloud service account, and shared with the user's smart home devices (e.g., Apple TV® and HomePod®). The cloud service account may be an account associated with a cloud storage and synchronization service that allows the user to share and access its data across multiple devices.

In some embodiments, the mobile device may notify the user's home devices if a matched status exists for the particular network. In other embodiments, the user's home devices may periodically look up the user's cloud service account to see whether the associated network state information is available for the particular network and determine whether to perform Wi-Fi scans. Since the location of the associated network state information is accurate, the home devices can simply rely on the associated network state information of the particular network (e.g., home network or work network) it connects to and avoid the need to perform Wi-Fi scans for other networks. As a result, the techniques save resources and bandwidth, and achieve better performance for the user's home devices. If a home device is not associated with the identified network, it may then perform Wi-Fi scans.

Additionally, background location positioning techniques may be used by the mobile device to periodically provide up-to-date associated network state information of the PAAP for the home devices. The mobile device may collect location data (or information) using Wi-Fi scans by an auxiliary processor and store the data in a buffer while the mobile device is in a low-power state (e.g., sleep mode), and process the stored historical location data for later use (e.g., when a main processor of the mobile device wakes up).

Embodiments of the present disclosure provide a number of advantages/benefits. For example, the associated network state information provided by the mobile device allows the home devices to save resources (e.g., power, storage) and network bandwidth, leading to better performance for many services for smart home automation. Furthermore, the location information in the associated network state information is more accurate than the crowdsourced location information from the Wi-Fi scans. Finally, without the frequent Wi-Fi scan, which may interfere with other services and consume more resources (e.g., storing information from the scan for other networks), home devices can provide a better user experience.

### I. Difficulties in Location Determination of Home Devices

A home device of a smart home may need to know its location to optimize or adjust its functions, such as in location-based home automation. For example, a home device may turn on/off lights or thermostats depending on whether a user is close to the location accordingly. Wireless fidelity (Wi-Fi) or other wireless network scan (also referred to as a first wireless protocol) that can scan the nearby wireless networks around the home device may be used to determine its location for the home automation purpose. Examples of wireless protocols that may be used include Wi-Fi, Bluetooth (BT), UWB, Zigby, Z-wave, Insteon, Thread, etc.

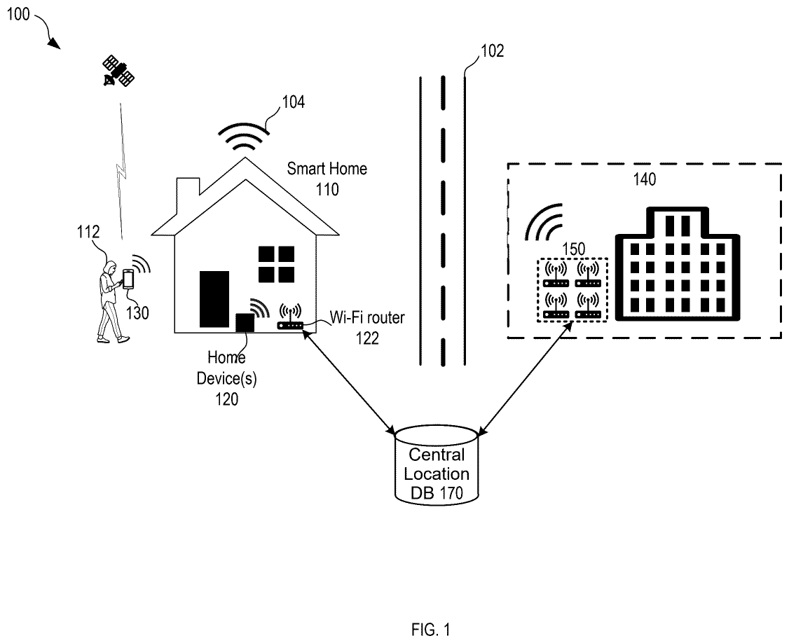

When a smart home device likes to know its location, the home device may perform Wi-Fi scans to identify nearby wireless networks and their locations (called crowdsourced location information), and use the collected information to estimate its location. However, location determination using Wi-Fi scans may not be reliable due to many factors, such as unstable and fluctuating signals from other wireless networks. FIG. 1 is a simplified diagram illustrating a technique for determining a location by a home device of a smart home, but may have some limitations, according to some embodiments.

For the purpose of this application, a home device may refer to a smart electronic device that is semi-stationary (i.e., not permanent and can be moved occasionally) and designed for smart home integration and entertainment, such as HomePod® (i.e., a device that can act as a central hub for smart home control and voice-activated tasks) and Apple TV® (i.e., a device for home entertainment, combining streaming capabilities with smart home functionality). A smart home, as part of internet of things (IoT), may a residence that uses internet-connected devices to enable remote monitoring and management of appliances. In some embodiments, a home device, such as HomePod® and Apple TV® may act as a central control point in a smart home, and is referred to as a home hub. Other home devices, such as lights, locks, thermostats, cameras, etc., being controlled by the home hub, are referred to as smart devices or Internet of Things (IoT) devices. In this application, the home hub and home device may be used interchangeably.

In FIG. 1, a smart home 110, which may be in an apartment or in an office, may be located across a street 102 from buildings in a dense urban area, such as an apartment complex 140, with many wireless networks 150 (and their access points (APs)). A home device (or home hub) 120 designed for smart home automation may perform Wi-Fi scans often so as to confirm its location to enhance user experience. For example, home device(s)/home hub(s) 120 of a user 112 or an owner needs to know its location (e.g., a home or an office) to create a geo-fence around that location, such that when the user 112 carrying a mobile device 130 (e.g., mobile phone, wearable watch, etc.) enters or leave that fence, notifications or actions may be triggered. The home device(s) 120, which may have a local database storing location information, can perform Wi-Fi scans (e.g., each for about half a second) to find out what networks are available. If a network is available, the home device can check whether the location information for that network is in its local database, and request the location information from a central location database 170 (described below) accordingly if it is not in its database. Specifically, a scan identifies multiple networks, such as network 122 of the smart home 110 and other nearby wireless networks (e.g., a group of networks 150 of the apartment complex 140), and then the home device can determine its location based on crowdsourced location information of those networks, for example, by averaging them together to get an averaged 2D position.

For the purpose of this application, a central location database 170 may be a database maintained by location service providers (e.g., Apple, Google, Microsoft, etc.) servicing many customer users and contain mappings of basic service set identifier (BSSID, a MAC address of access point or wireless router) to geographic coordinates of Wi-Fi access points. An access point may be a bridge between wireless devices and a wired network. The central location database 170 may be created by collecting location data sent by mobile devices moving around the world, where these mobile devices with GPS capabilities may scan for nearby Wi-Fi networks and send BSSIDs of these Wi-Fi networks and the mobile device's GPS coordinates to the location service provider. As a result, the location service provider can correlate the GPS coordinates and the Wi-Fi networks to create the central location database 170. In some embodiments, when a Wi-Fi-enabled device likes to know its location, the device may perform Wi-Fi scans to collect information (e.g., BSSIDs and corresponding signal strengths) about nearby access points, and send the information to a location service provider's server, which uses the submitted BSSID information to query its central location database (e.g., 170) to estimate the device's location (referred to as triangulation). The estimated location is then sent back to the requesting device.

Returning to the home device in FIG. 1, however, the crowdsourced location information obtained by the home device(s) 120 may not be reliable due to information from other networks. For example, poor or unstable Wi-Fi signals may result from many factors, such as physical obstacles (e.g., walls), interference (e.g., signals using the same channel), and environment (e.g., weather). The low density of Wi-Fi networks may reduce the accuracy of the location estimate. In some instances, some location information of other networks (e.g., 150) in the central location database 170 may be out-of-date. For instance, a Wi-Fi router for a network may be moved (e.g., from location A to location B, but the central location database still has location A) recently, and the central location database 170 may take some time to update the corresponding location for that Wi-Fi router.

In addition to unreliable location information, the Wi-Fi scans may degrade the performance of home devices. For example, Wi-Fi scans may interfere with other communication arising from activities performed by Wi-Fi or Bluetooth (BT) devices, such as when streaming a movie with audio. Glitches can occur due to the overburdened antenna since these devices may share the antenna. For example, a user may try to download or stream a video, although network bandwidth may be limited. When the Wi-Fi also tries to scan for locations, the Wi-Fi scan may interfere with or interrupt the video streaming, leading to performance issues for the home devices. Thus, there is a need to address these challenges and others.

### II. Example Home Device and Mobile Device for Dwell Location Determination

This section discusses an example home device that can enable smart home automation, and an example mobile device that can assist in determining the dwell location of the smart home utilizing a local wireless network for smart home automation.

As discussed above, home device(s)/home hub(s) 120 in a smart home 110 may be able to detect the presence of a mobile device 130, or even interact with the mobile device 130 through a shared cloud service account of the user 112. For example, when the user 112 is away from the smart home 110, the user 112 may use the mobile device 130 to control IoT devices in the smart home 110 by communicating with the home device(s) 120. In some embodiments, the mobile device 130 may be able to assist the home device(s) 120 to obtain a more accurate location.

Dwell location may be a location where the user stays for sufficient time (e.g., home or work), and can be used as a proxy for determining a particular wireless network (e.g., home network or work network). A measured location using location sensors by the mobile device when connecting to the particular wireless network may be considered the dwell location.

### A. Home Device

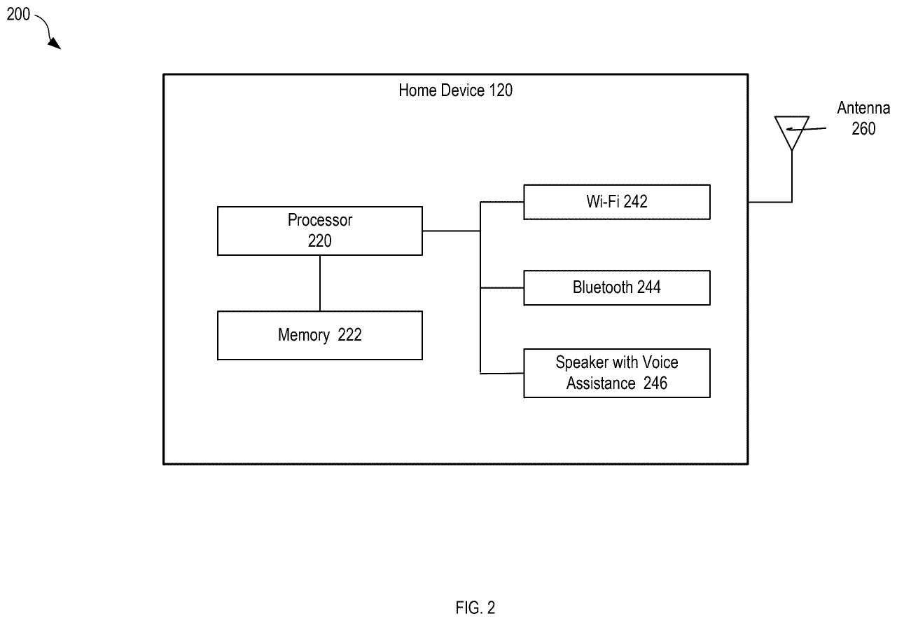

FIG. 2 is a simplified functional diagram of a home device 120 of the smart home 110, according to some embodiments. As illustrated in FIG. 2, the processor 220, the memory 222, Wi-Fi 242, Bluetooth 244, the speaker with voice assistance 246, and antenna 260, may be communicatively coupled directly or indirectly (e.g., through or via another component, a communication bus, a network) to one another to transmit and/or receive data between one another.

In FIG. 2, the Wi-Fi 242 of the home device(s) 120 may enable the home device(s) 120 to perform Wi-Fi scans to obtain the estimated location of the home device, as discussed above. The Bluetooth 244 of the home device(s) 120 may enable the home device(s) 120 to communicate locally with other home devices in the smart home 110 without internet access. In some embodiments, a home device may include one or more speakers with voice assistance 246 that enable the home device (e.g., HomePod) 120 to control other IoT devices (e.g., lights, thermostats, locks, etc.) through voice commands. In some embodiments, Wi-Fi 242 and Bluetooth 244 may share the same antenna, for example, due to space constraints. In other embodiments, Wi-Fi 242 and Bluetooth 244 may have separate antennas, for example, for performance consideration.

### B. Mobile Device

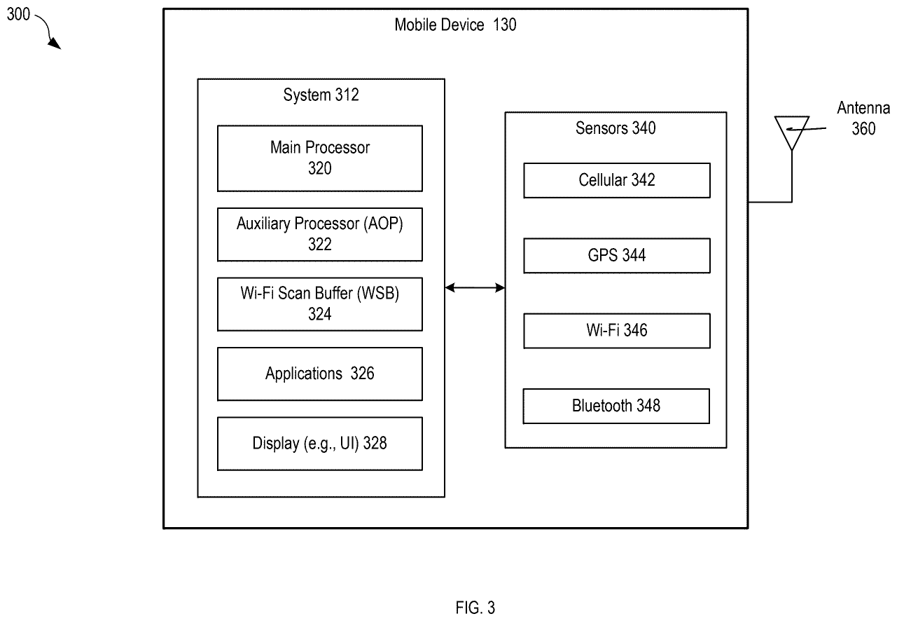

FIG. 3 is a simplified functional diagram of a mobile device 130 assisting in determining the location of a smart home 110, according to some embodiments. As illustrated in FIG. 2, the mobile device 130 may include a system 312, and sensors 340. The system 312 may include, but is not limited to, a main processor 320, an auxiliary processor (also referred to as always-on processor (AOP)) 322, a Wi-Fi scan buffer (WSB) 324, applications 326 (e.g., Siri, smart control applications), and display 328 (e.g., user interface (UI)). The sensors of location technologies (called location sensors) may include, but are not limited to, cellular 342, global positioning system (GPS) 344, Wi-Fi 346, Bluetooth 348, and one or more antennas 360.

Compared to home device(s)/home hub(s) 120, the mobile device 130 can determine a more accurate location using one or more location technologies, or a combination of these technologies. For example, in addition to Wi-Fi 346 and Bluetooth 348, as discussed above, cellular 342 and GPS 344 enable the mobile device 130 to determine outdoor locations fairly accurately. GPS may obtain accurate location (e.g., within 4-8 meters) by utilizing multiple satellites with sophisticated timing measurements. Cellular positions may obtain locations by measuring the strength and timing of signals from multiple cell towers. In some embodiments, the mobile device 130 may use multiple data sources from these location technologies to improve accuracy in different environments (e.g., indoor, outdoor, dense urban areas, etc.). In some embodiments, the sensors 340 of these location technologies may share the same antenna, or use different antennas.

In some embodiments, the AOP 322 and WSB 324 may enable the mobile device 130 to perform Wi-Fi scans in the background, for example, while the mobile device is in a low-power state (e.g., main processor 320 is in sleep mode). Such techniques are referred to as background location positioning (or WSB techniques). Further details on the background location positioning are described below.

### III. Managing Wi-Fi Scans Using Measurements by a Mobile Device

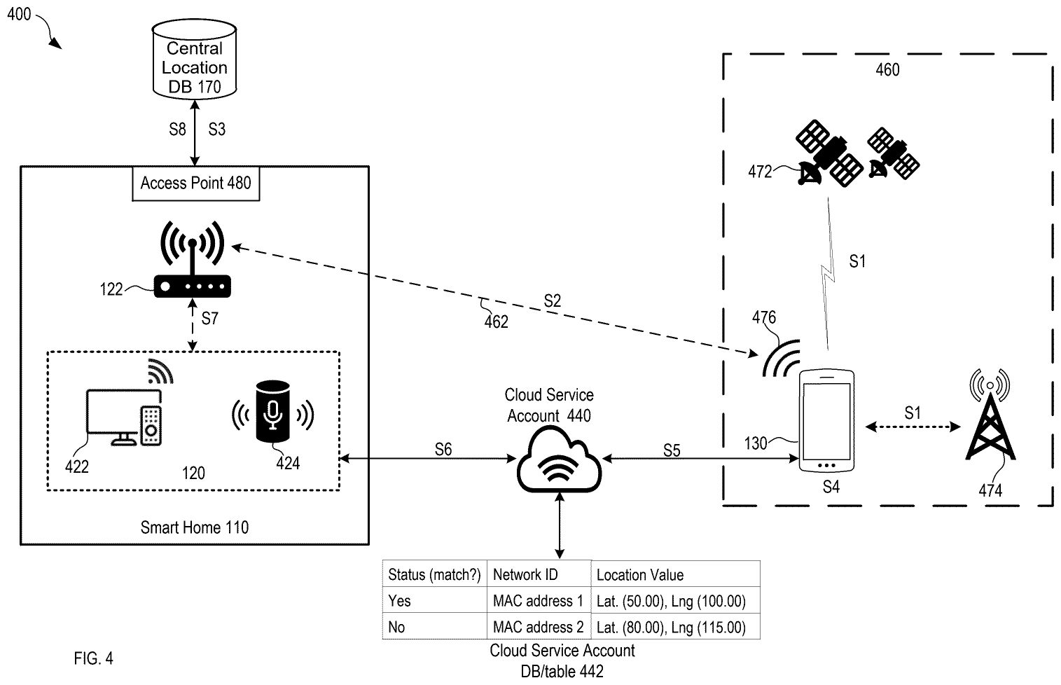

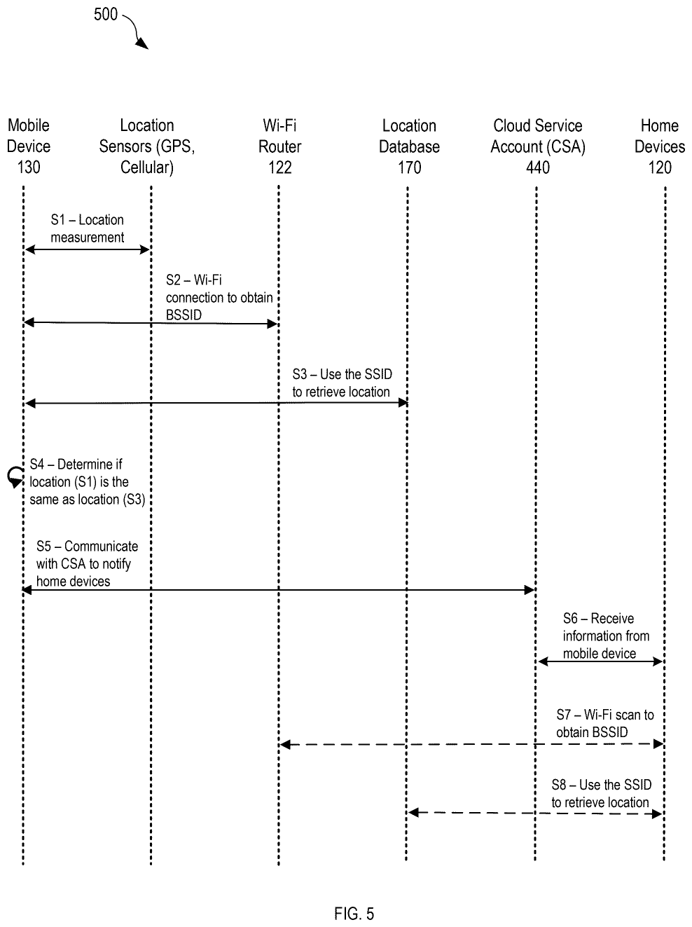

The disclosed techniques enable a system that can utilize a mobile device's ability to determine accurate location to assist home devices in obtaining a more accurate location (i.e., PAAP) of the smart home while saving resources and bandwidth of the home device. The disclosed techniques may include two parts: (1) creating associated network state information in a database or table of a user's cloud service account by the user's mobile device, and (2) using the associated network state information by the user's home devices. Both FIGS. 4 and 5 illustrate the techniques for managing Wi-Fi scans using measurements by a mobile device. FIG. 4 focuses on the system and sub-systems/components/devices involved in the disclosed techniques, while FIG. 5 focuses on the data flow and interaction among the sub-systems/components/devices in FIG. 4.

In FIG. 4, a smart home 110 may include a wireless router 122 (also referred to as a home network), and one or more home device(s) 120, such as an Apple TV® 422 and a HomePod® 424. The home device(s) 120 may be semi-stationary, and can be moved occasionally within the smart home 110 or to a different smart home. In some embodiments, multiple home networks (e.g., several wireless routers) may exist in a smart home. The geographical location of the network (called home network) created by the wireless router 122, along with locations of other networks, may be stored in the central location database 170 of a location service provider. A location positioning environment 460 in which the mobile device 130 can utilize a combination of one or more location sensors/technologies/providers (e.g., hybrid approach), such as GPS 472, cellular 474, and Wi-Fi scan 476, as discussed above in relation to FIG. 3, to perform location positioning to accurately determine the geographic location (e.g., a latitude and longitude coordinate) or PAAP 480 of the smart home 110. A cloud service account 440 of user 112 may include a database (or a table in the database, called database table) 442, which stores associated network state information. The associated network state information may include, but is not limited to, status indicators, network IDs, and location values. The associated network state information in the cloud service account 440 can be shared between the mobile device 130 and the home device(s) 120.

### A. Creating Associated Network State Information

As discussed above, the disclosed techniques for managing Wi-Fi scans using measurements of a mobile device may include two parts, creating associated network state information in a database of a user's cloud service account, and using the associated network state information by the user's home devices to avoid performing Wi-Fi scans. The location positioning environment 460 of FIG. 4 may be responsible for the first part, creating associated network state information.

For example, in FIGS. 4 and 5, at S1, the mobile device 130 may communicate with location sensors (e.g., GPS 472 and cellular 474) to determine/measure its location. In some embodiments, the location determination may rely on a particular location technology if the signal is adequate, for example, using GPS outdoors when the GPS signal is strong or cellular location if there are nearby cell towers with strong signals. In other embodiments, the location estimate may be performed by averaging the estimated results from multiple location technologies, such as GPS, cellular, and Wi-Fi.

At S2, the mobile device 130 may connect to (via 462) the home network 122, for example, using a Wi-Fi scan 476, to obtain the BSSID of the access point 480 (or PAAP) of the home network 122 created by the wireless router 122. In some embodiments, S1 and S2 may be performed in parallel, such that the mobile device 130 is within the range of the home network 122 when it performs the location measurement using location sensors (e.g., GPS 472 and cellular 474). The measured location by the mobile device 130 when connecting to the home network 122 may be the dwell location.

At S3, the mobile device 130 may send the obtained BSSID and signal strength to a location service provider's server to query the central location database 170, and receive the location information (i.e., provider location, e.g., geographical location such as a latitude and longitude coordinate) for access point 480 of the home network 122.

As S4, the mobile device 130 may determine (or verify) whether the provider location (i.e., the location of the access point 480 retrieved from the central location database 170 in S3) matches the measured location (i.e., the location of the smart home 110 measured using its location sensors in S1). The verified result (or status—e.g., match or not), BSSID of the access point associated with the home network, and the measured location (or dwell location if the mobile device is connected to the home network 122) become part of an associated network state information. In some embodiments, the status indicator may be a single-bit match indicator (yes or no). The measured location (called location value) may be represented as a latitude and longitude coordinate.

At S5, the mobile device 130 may store the associated network state information in database table 442 of cloud service account 440. In some embodiments, the information (or data) sent (or stored) by the mobile device 130 to the user's cloud service account 440 may be encrypted using the user's cryptographic keys for security purposes.

### B. Using Associated Network State Information

The second part of the disclosed techniques for managing Wi-Fi scans using measurements of a mobile device may be using the associated network state information by the home device(s) 120 of FIG. 4 to determine whether the home device(s) should perform Wi-Fi scans for determining its location (or the dwell location).

Continuing with the above discussion, at S6, the home device(s)/home hub(s) 120 may obtain the associated network state information stored in the database table 442 of the user's cloud service account 440. In some embodiments, the data between the mobile device 130 and the home device(s) 120 is synchronized in the user's cloud service account 440 so that all devices accessing the account can see the updated associated network state information.

When the home device(s) 120 is connected to the home network 122, the home device(s) 120 may use the BSSID of the access point 480 (or PAAP) to look up the database table 442 of cloud service account 440 to check the status indicator and retrieve the stored location value. For example, if the home network has a network ID (or BSSID) as MAC address 1, the home device(s) 120 may access the first row of the database table 442. In some embodiments, if the status (or verified result) of the associated network state information indicates a match between the provider location and measured location, the mobile device 130 may notify the home device(s) 120 In some embodiments, the mobile device 130 may notify the home device(s) 120 whenever there is a status change (e.g., no match to match, or vice versa). In other embodiments, the home device(s) 120 may check the database table 442 whenever it needs to determine its current location since the associated network state information may be updated periodically by the mobile device 130 performing background location positioning (discussed below).

The home device(s) 120 may be triggered (e.g., receives a trigger signal from the user) to access the database table 442 of cloud service account 440 for home automation (e.g., controlling IoT devices or home appliances), including using location-based services (e.g., geofencing features, finding best available network, etc.), or when receiving notifications (or trigger signals) from the mobile device 130 indicating the updated associated network state information is available.

In some embodiments, if the status bit of the associated network state information indicates a match (i.e., the home network 122 is associated with the smart home location 110 (i.e., the dwell location), the home device(s) 120 may use the location value stored in the database table 442 of the user's cloud service account 440 for smart home automation purpose without performing Wi-Fi scans.

However, if the status bit of the associated network state information is a no match or the associated network state information cannot be found, which may indicate, for example, that the location information of the home network 122 is out-of-date in the central location database 170 or the home device(s) 120 is not connected to the home network 122, the home device(s) 120 may perform Wi-Fi scans (as shown in S7) to obtain crowdsourced location information related to neighboring networks by inquiring the central location database 170 (as shown in S8) to determine its current location, as discussed above in relation to FIG. 1.

Alternatively, the home device(s) 120 may be configured to rely on the measured location by the user's mobile device in S1 under such situation if the measured location estimate is deemed more reliable. In some embodiments, the mobile device 130 may perform background location positioning (discussed below) and update the location information in the cloud service account 440 periodically (e.g., every 15 minutes to an hour), such that the home device(s) 120 can use that up-to-date location information in the cloud service account 440 instead of performing Wi-Fi scanning.

### C. Flowchart

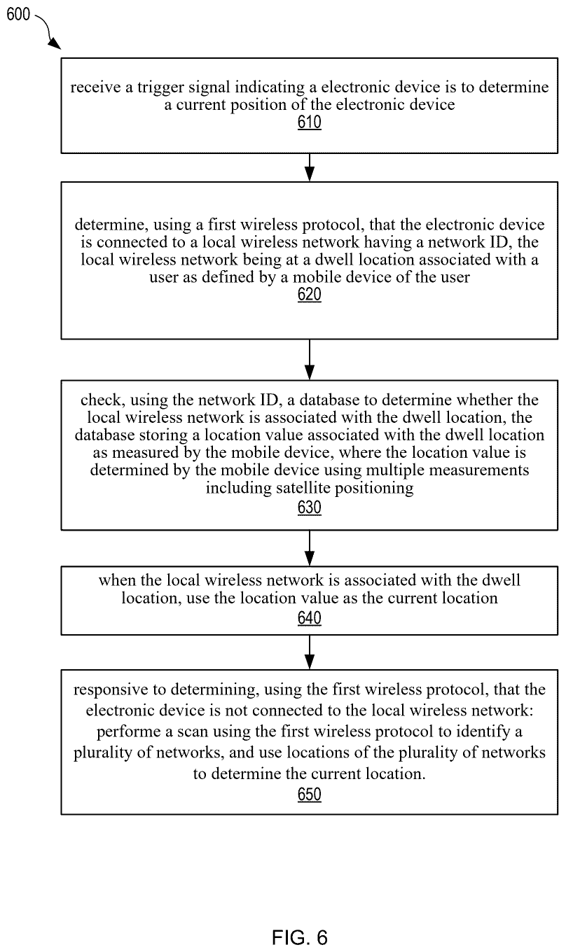

FIG. 6 is a flowchart 600 illustrating a method for managing Wi-Fi scans using measurements of a mobile device, according to some embodiments. The method presented in FIG. 6 and described below is intended to be illustrative and non-limiting. Although FIG. 6 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 6 may include a greater number or a lesser number of steps than those depicted in FIG. 12.

At block 610, a trigger signal indicating an electronic device is to determine a current position of the electronic device may be received. For example, in FIG. 4, one of the home devices (or home hubs) 120 (i.e., an example of the electronic device), such as an Apple TV 422 and a HomePod 424, may receive a request from a user 112 of FIG. 1 to perform smart home automation. Such a request may trigger a home device (either 422 or 424) to determine its current location (i.e., the location of the smart home 110).

At block 620, a first wireless protocol may be used to determine that the electronic device is connected to a local wireless network having a network ID. The local wireless network can be at a dwell location (e.g., a home, a workplace, or a place a user stays at for sufficient time) associated with a user as defined by a mobile device of the user. For example, in FIGS. 4 and 5, the mobile device 130 and the home device(s) 120 may use Wi-Fi (i.e., an example of the first wireless protocol) to communicate with each other through the wireless router 122 to determine that the home device(s) 120 is connected to the home network (i.e., an example of the local wireless network) created by the wireless router 122. The access point of the wireless router 122 may have a BSSID (i.e., the network ID). Examples of wireless protocols that may be used include Wi-Fi, Bluetooth (BT), UWB, Zigby, Z-wave, Insteon, Thread, etc.

The smart home 110 (i.e., an example of the dwell location) may be associated with user 112, who owns the mobile device 130. Accordingly, the electronic device and the mobile device may be devices of a same user. As another example, they are devices of different users but both associated with a shared account, e.g., a family account. As another example, the mobile device can provide authorization to the electronic device to access the location value stored in the database. For instance, a person can provide access to a friend or guest so that while that person is visiting, those locations can be used for the electronic device.

The dwell location may be the measured location by the mobile device 130 using location sensors, e.g., GPS 472 and cellular 474) when connecting to the home network 122 (i.e., within the range of the home network 122), as discussed in S1 to S3 of FIGS. 4 and 5.

At block 630, the network ID can be used to check a database to determine whether the local wireless network is associated with the dwell location. The database may store a location value associated with the dwell location as measured by the mobile device, where the location value is determined by the mobile device using multiple measurements using wireless communications to devices external to the dwell location and having known locations. As examples, such measurement may include satellite positioning (e.g., GPS, GNSS, etc.) or positioning using cellular towers (e.g., using triangulation). In both instances, the satellites or the cellular towers positions. And such cellular towers or satellites are external to someone's home, etc., which correspond to a dwell location.

For example, as discussed in S4 to S5 of FIGS. 4 and 5, the mobile device 130 may store the associated network state information in database table 442 (an example of the database) of cloud service account 440. The associated network state information may include a status indicating whether the local wireless network is associated with the dwell location (i.e., the provider location of the home network 122 matches the measured location (or dwell location)), a measured location (an example of location value) by the mobile device 130 using location sensors (an example of multiple measurements), and a BSSID (or MAC address, an example of network ID) of PAAP 480 associated with the home network 122.

When the home device(s) 120 is connected to the home network 122, the home device(s) 120 may use the network ID to look up the database table 442 of cloud service account 440 to check the status indicator, as discussed in S6 of FIGS. 4 and 5.

At block 640, when the local wireless network is associated with the dwell location, the location value can be used as the current location. For example, as discussed in S6 of FIGS. 4 and 5, if the status bit of the associated network state information indicates a match (i.e., the home network 122 is associated with the smart home location 110 (i.e., the dwell location)), the home device(s) 120 may use the location value stored in database table 442 of the user's cloud service account 440 as its current location for smart home automation purpose.

At block 650, responsive to the determination, using the first wireless protocol, that the electronic device is not connected to the local wireless network, a scan may be performed using the first wireless protocol to identify a plurality of networks, and locations of the plurality of networks can be used to determine the current location. For example, as discussed in S7 to S8 of FIGS. 4 and 5, if the status bit of the associated network state information indicates a no match (i.e., the home device(s) 120 is not connected to the home network 122), then the home device(s) 120 may perform Wi-Fi scans (as shown in S7) to obtain crowdsourced location information related to neighboring networks by inquiring the central location database 170 (as shown in S8) to determine its current location.

### IV. Wi-Fi Scan Buffer

As discussed above, a mobile device (e.g., 130) may perform background location positioning periodically to provide up-to-date location information for the home devices (e.g., 120), for example, personalized associated AP (PAAP). Such techniques for performing background location positioning may utilize a Wi-Fi scan buffer (WSB) 324 of FIG. 3.

The background location positioning techniques can enable a mobile device (e.g., 130) to collect location data (or information) using Wi-Fi scans and store the data in a WSB 324 while the mobile device is in a low-power state (e.g., sleep mode), and process the stored historical location data for later use (e.g., when a main processor of the mobile device wakes up).

A Wi-Fi scan buffer refers to a buffer or memory on the mobile device such that the Wi-Fi chip's firmware may keep a record of the scans during a background process that happens while the main processor (e.g., CPU) 320 on the mobile device is asleep. When the mobile device wakes up, its main processor can process (or analyze) historical information stored in the buffer to determine the particular network, and accurate location of the particular network (e.g., home network), as described above. The WSB 324 can provide scan results with what AP the mobile device is associated with. In some embodiments, any measurements can be saved in WSB 324, accessible by an auxiliary processor (referred to as an always-on processor (AOP)) 322 that can be powered on more often than the main processor 320 (e.g., CPU). In some embodiments, AOP 322 may be designed to have more memory and cover more access points per scan than normal processors.

In some embodiments, an associated network state information for the PAAP, indicating whether the mobile device 130 is associated with the home network 122, may be generated at S4 of FIG. 5. The state information may include a Boolean bit indicating association status (e.g., yes/no) and a MAC address of the home network's access point the mobile device is associated with. This state information can be stored in the WSB 324. For example, with the collected location information from background location positioning and history of GPS samples, the mobile device 130 can provide periodic updates (e.g., 15 minutes to 1 hour) about what networks the mobile device is associated with (i.e., which wireless network is at which location based on GPS samples, e.g., within a GPS bubble of 20 meters) and whether the home network 122 is currently associated with the smart home location 110. Such information can be useful to the home device(s) 120.

The associated network state information for the PAAP may be smaller compared to a Wi-Fi scan result performed by the home device(s) 120, which may include multiple MAC addresses, RSSI timestamps, etc. Thus, location information provided by the mobile device 130 assisting the home device(s) 120 through the cloud service account 440 can save more resources (e.g., storage space), power, and bandwidth for the home device(s) 120 than having the home device(s) 120 perform Wi-Fi scans.

### V. Example Device

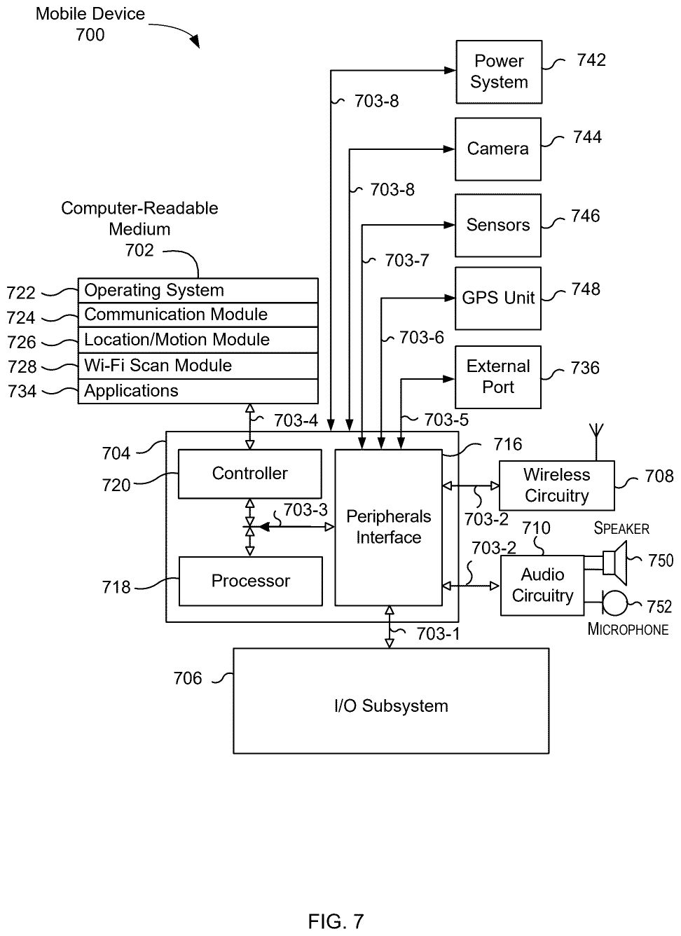

FIG. 7 is a block diagram of an example device 700, which may be a mobile device. Device 700 generally includes computer-readable medium 702, a processing system 704, an Input/Output (I/O) subsystem 706, wireless circuitry 708, and audio circuitry 710 including speaker 750 and microphone 752. These components may be coupled by one or more communication buses or signal lines 703. Device 700 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 7 is only one example of an architecture for device 700, and that device 700 can have more or fewer components than shown, or a different configuration of components. The various components shown in FIG. 7 can be implemented in hardware, software, or a combination of both hardware and software, including one or more signal processing and/or application specific integrated circuits.

Wireless circuitry 708 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 708 can use various protocols, e.g., as described herein.

Wireless circuitry 708 is coupled to processing system 704 via peripherals interface 716. Interface 716 can include conventional components for establishing and maintaining communication between peripherals and processing system 704. Voice and data information received by wireless circuitry 708 (e.g., in speech recognition or voice command applications) is sent to one or more processors 718 via peripherals interface 716. One or more processors 718 are configurable to process various data formats for one or more application programs 734 stored on medium 702.

Peripherals interface 716 couple the input and output peripherals of the device to processor 718 and computer-readable medium 702. One or more processors 718 communicate with computer-readable medium 702 via a controller 720. Computer-readable medium 702 can be any device or medium that can store code and/or data for use by one or more processors 718. Medium 702 can include a memory hierarchy, including cache, main memory, and secondary memory.

Device 700 also includes a power system 742 for powering the various hardware components. Power system 742 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management, and distribution of power in mobile devices.

In some embodiments, device 700 includes a camera 744. In some embodiments, device 700 includes sensors 746. Sensors 746 can include accelerometers, compasses, gyrometers, pressure sensors, audio sensors, light sensors, barometers, and the like. Sensors 746 can be used to sense location aspects, such as auditory or light signatures of a location.

In some embodiments, device 700 can include a GPS receiver, sometimes referred to as a GPS unit 748. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 700 may be configured to identify GLONASS signals, or any other similar type of satellite navigational signal.

One or more processors 718 run various software components stored in medium 702 to perform various functions for device 700. In some embodiments, the software components include an operating system 722, a communication module (or set of instructions) 724, a location module (or set of instructions) 726, a Wi-Fi scan module 728, a predicted app manager module 730, and other applications (or set of instructions) 734, such as a car locator app and a navigation app.

Operating system 722 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 724 facilitates communication with other devices over one or more external ports 736 or via wireless circuitry 708 and includes various software components for handling data received from wireless circuitry 708 and/or external port 736. External port 736 (e.g., USB, FireWire, Lightning connector, 60-pin connector, etc.) is adapted for coupling directly to other devices or indirectly over a network (e.g., the Internet, wireless LAN, etc.).

Location/motion module 726 can assist in determining the current position (e.g., coordinates or other geographic location identifier) and motion of device 700. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 726 receives data from GPS unit 748 and analyzes the signals to determine the current position of the mobile device. In some embodiments, location/motion module 726 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 708 and is passed to location/motion module 726. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 700 based on the position coordinates of the corresponding transmitters. Regardless of the specific location technology used, location/motion module 726 receives information from which a location fix can be derived, interprets that information, and returns location information, such as geographic coordinates, latitude/longitude, or other location fix data.

Wi-Fi scan module 728 can include various sub-modules or systems, e.g., as described herein with respect to FIG. 1 and earlier discussion.

The one or more application programs 734 on the mobile device can include any applications installed on the device 700, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 706 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 706 can include a display and user input devices such as a keyboard, mouse, and/or track pad. In some embodiments, I/O subsystem 706 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 702) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 700 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A method, comprising:
receiving a trigger signal indicating an electronic device is to determine a current location of the electronic device;
determining, using a first wireless protocol, that the electronic device is connected to a local wireless network having a network identification (ID), the local wireless network being at a dwell location associated with a user as defined by a mobile device of the user;
checking, using the network ID, a database to determine whether the local wireless network is associated with the dwell location, the database storing a location value associated with the dwell location as measured by the mobile device, wherein the location value is determined by the mobile device using multiple measurements using wireless communications to devices external to the dwell location and having known locations;
when the local wireless network is associated with the dwell location, using the location value as the current location; and
responsive to determining, using the first wireless protocol, that the electronic device is not connected to the local wireless network:
performing a scan using the first wireless protocol to identify a plurality of networks; and
using locations of the plurality of networks to determine the current location.

2. The method of claim 1, wherein the dwell location is determined by:
performing, by the mobile device, global positioning system (GPS) measurements when connected to the local wireless network; and
determining, by the mobile device, a final location using the GPS measurements.

3. The method of claim 1, wherein the location value comprises a latitude and longitude coordinate.

4. The method of claim 1, wherein the electronic device and the mobile device are devices of a same user or a shared account, or wherein the mobile device has provided authorization to the electronic device to access the location value stored in the database.

5. The method of claim 4, wherein using the location value as the current location further comprises:
storing, by the mobile device, the location value in a cloud service account of the user; and
accessing, by the electronic device, the stored location value from the cloud service account.

6. The method of claim 5, wherein the cloud service account further comprises the network ID and a status indicator stored by the mobile device, wherein the status indicator indicates whether the local wireless network is associated with the dwell location.

7. The method of claim 1, wherein the electronic device is a semi-stationary.

8. The method of claim 1, wherein the first wireless protocol is a wireless fidelity (Wi-Fi) protocol.

9. The method of claim 1, further comprising storing the location value in a storage of the mobile device by a background process while the mobile device is not active.

10. The method of claim 1, wherein the plurality of networks are wireless networks close to the dwell location.

11. An electronic device, comprising:
one or more processors; and
a memory coupled to the one or more processors, the memory storing instructions that cause the one or more processors to perform any one or more of operations comprising:
receiving a trigger signal indicating the electronic device is to determine a current location of the electronic device;
determining, using a first wireless protocol, that the electronic device is connected to a local wireless network having a network identification (ID), the local wireless network being at a dwell location associated with a user as defined by a mobile device of the user;
checking, using the network ID, a database to determine whether the local wireless network is associated with the dwell location, the database storing a location value associated with the dwell location as measured by the mobile device, wherein the location value is determined by the mobile device using multiple measurements using wireless communications to devices external to the dwell location and having known locations;
when the local wireless network is associated with the dwell location, using the location value as the current location; and
responsive to determining, using the first wireless protocol, that the electronic device is not connected to the local wireless network:
performing a scan using the first wireless protocol to identify a plurality of networks; and
using locations of the plurality of networks to determine the current location.

12. The electronic device of claim 11, wherein the dwell location is determined by:
performing, by the mobile device, global positioning system (GPS) measurements when connected to the local wireless network; and
determining, by the mobile device, a final location using the GPS measurements.

13. The electronic device of claim 11, wherein the location value comprises a latitude and longitude coordinate.

14. The electronic device of claim 11, the electronic device and the mobile device are devices of a same user.

15. The electronic device of claim 14, wherein using the location value as the current location further comprising:
storing, by the mobile device, the location value in a cloud service account of the user; and
accessing, by the electronic device, the stored location value from the cloud service account.

16. A non-transitory, computer readable medium, the non-transitory computer readable medium storing instructions that when executed on one or more processors, cause the one or more processors to perform operations comprising:
receiving a trigger signal indicating an electronic device is to determine a current location of the electronic device;
determining, using a first wireless protocol, that the electronic device is connected to a local wireless network having a network identification (ID), the local wireless network being at a dwell location associated with a user as defined by a mobile device of the user;
checking, using the network ID, a database to determine whether the local wireless network is associated with the dwell location, the database storing a location value associated with the dwell location as measured by the mobile device, wherein the location value is determined by the mobile device using multiple measurements using wireless communications to devices external to the dwell location and having known locations;
when the local wireless network is associated with the dwell location, using the location value as the current location; and
responsive to determining, using the first wireless protocol, that the electronic device is not connected to the local wireless network:
performing a scan using the first wireless protocol to identify a plurality of networks; and
using locations of the plurality of networks to determine the current location.

17. The non-transitory computer readable medium of claim 16, wherein the dwell location is determined by:
performing, by the mobile device, global positioning system (GPS) measurements when connected to the local wireless network; and
determining, by the mobile device, a final location using the GPS measurements.

18. The non-transitory computer readable medium of claim 16, wherein the location value comprises a latitude and longitude coordinate.

19. The non-transitory computer readable medium of claim 16, wherein the electronic device and the mobile device are devices of a same user.

20. The non-transitory computer readable medium of claim 19, wherein using the location value as the current location further comprising:
storing, by the mobile device, the location value in a cloud service account of the user; and
accessing, by the electronic device, the stored location value from the cloud service account.
